(19) United States
(12) Patent Application Publication
(10) Pub. No.: US 2009/0098305 A1
(43) Pub. Date: Apr. 16, 2009

(54) RADIATION CURABLE COATING COMPOSITIONS, RELATED COATINGS AND METHODS

(75) Inventors: Shan Cheng, Sewickley, PA (US); Anthony M. Chasser, Allison Park, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/247,260

(22) Filed: Oct. 8, 2008

Related U.S. Application Data
(60) Provisional application No. 60/978,886, filed on Oct. 10, 2007.

(51) Int. Cl. B05D 3/06; C08K 3/36

(52) U.S. Cl. 427/520; 524/493

(57) ABSTRACT

Disclosed are radiation curable coating compositions, cured coatings formed therefrom, related methods for coating a substrate, and related coated substrates.

### CROSS-REFERENCE TO RELATED APPLICATIONS

This application claims the benefit of U.S. Provisional Application Ser. No. 60/978,886, filed Oct. 10, 2007, which is incorporated herein by reference.

### FIELD OF THE INVENTION

The present invention is directed to radiation curable coating compositions, radiation cured coatings formed therefrom, related methods for coating a substrate, and related coated substrates.

### BACKGROUND OF THE INVENTION

Plastic substrates, including transparent plastic substrates, are desired for a number of applications, such as windshields, lenses, and consumer electronics devices (including, for example, cellular telephones, personal digital assistants, smart phones, personal computers, digital cameras, and the like), among other things. To minimize scratching, as well as other forms of degradation, clear “hard coats” are often applied as protective layers to the substrates.

In some cases, such “hard coats” are formed from the hydrolysis and condensation of one or more alkoxysilanes. Coatings formed from such a mechanism can be very abrasion resistant. In certain industries, however, they are not as easily utilized as coatings that employ organic binder materials, such as organic binder materials curable upon exposure to actinic radiation.

More recently, hybrid organic-inorganic coatings have been proposed. These coatings employ particles, such as silica particles, dispersed in an organic binder, such as a UV curable organic binder. Hence, their identification as “hybrid organic-inorganic” coatings. The hybrid organic-inorganic coatings developed thus far, however, have not exhibited the combination of very high initial clarity (low haze) at relatively high film thicknesses (up to 2 mil), low color (low yellowing), good flexibility and abrasion resistance required in certain applications, such as certain applications involving the use of such coatings on consumer electronics devices.

It would be desirable, therefore, to provide improved hybrid organic-inorganic coating compositions that exhibit very high initial clarity (low haze) at relatively high film thicknesses (up to 2 mil), low color (low yellowing), good flexibility and abrasion resistance properties required in certain demanding applications. It has been discovered, surprisingly, that the use of a particular radiation curable organic film-forming binder, in combination with certain nanoparticles, can achieve such a desirable combination of properties.

### SUMMARY OF THE INVENTION

In certain respects, the present invention is directed to radiation curable coating compositions. These coating compositions comprise: (a) an organic film-forming binder comprising: (i) 10 to 60 percent by weight of a urethane (meth)acrylate comprising the reaction product of a polyol and a polyisocyanate comprising two (meth)acrylate groups per molecule, and (ii) 40 to 90 percent by weight of a highly functional (meth)acrylate; and (b) >10 and <40 percent by weight, based on the total weight of the binder, of particles having an average primary particle size of no more than 25 nanometers.

In other respects, the present invention is directed to radiation cured coatings. These cured coatings comprise: (a) an organic film-forming binder comprising a urethane (meth)acrylate comprising the reaction product of a polyol and a polyisocyanate comprising two (meth)acrylate groups per molecule; and (b) particles dispersed in the binder that have an average primary particle size of no more than 25 nanometers. The cured coatings have (1) a thickness of 3 to 20 microns, (2) an initial haze of <1%; and (3) a haze after 100 Taber cycles of <15%.

In still other respects, the present invention is directed to methods for coating a substrate. These methods comprise: (a) depositing onto at least a portion of the substrate a coating composition comprising: (1) a radiation curable organic film-forming binder comprising a urethane (meth)acrylate comprising the reaction product of a polyol and a polyisocyanate comprising two (meth)acrylate groups per molecule; and (2) particles having an average primary particle size of no more than 25 nanometers; and (b) curing the composition by exposing the composition to actinic radiation in air to produce a cured coating having (i) a thickness of 3 to 20 microns, (ii) an initial haze of <1%, and (iii) a haze after 100 Taber cycles of <15%.

The present invention is also directed to related coated substrates.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As previously indicated, certain embodiments of the present invention are directed to coating compositions that comprise an organic film-forming binder. As used herein, the term “film-forming binder” refers to binders that can form a self-supporting continuous film on at least a horizontal surface of a substrate upon removal of any diluents or carriers present in the composition or upon curing at ambient or elevated temperature. As used herein, the term “binder” refers to a continuous material in which particulate material, such as the particles that have an average primary particle size of no more than 25 nanometers (described in more detail below) are dispersed. As used herein, the term “organic film-forming binder” means that the film-forming binder comprises a backbone repeat unit based on carbon.

In certain embodiments, the coating compositions of the present invention are substantially or, in some cases, completely free of an inorganic film-forming binder, i.e., a film-forming binder having a backbone repeat unit based on an element or elements other than carbon, for example silicon. As a result, in certain embodiments, the coating compositions of the present invention are substantially or, in some cases, completely free of an alkoxide of the general formula RₓM(OR′)_{z-x} where R is an organic radical, M is silicon, aluminum, titanium, and/or zirconium, each R′ is independently an alkyl radical, z is the valence of M, and x is a number less than z and may be zero, such as is described in United States Patent Application Publication No. 2006/0247348 at paragraph [0011], the cited portion of which being incorporated herein by reference.

In certain embodiments, the coating compositions of the present invention are substantially or, in some cases, completely free of an organosilane, a hydrolyzate thereof, and/or a hydrolysis-condensation product thereof.

As used herein, the term “substantially free” means that the material being discussed is present in the composition, if at all, as an incidental impurity. In other words, the material does not affect the properties of the composition. As used herein, the term “completely free” means that the material is not present in the composition at all.

In certain embodiments, the organic film-forming binder is radiation curable, i.e., it is curable upon exposure to actinic radiation. “Actinic radiation” is light with wavelengths of electromagnetic radiation ranging from gamma rays to the ultraviolet (“UV”) light range, through the visible light range, and into the infrared range. Actinic radiation which can be used to cure certain coating compositions of the present invention generally has wavelengths of electromagnetic radiation ranging from 100 to 2,000 nanometers (nm), such as from 180 to 1,000 nm, or, in some cases, from 200 to 500 nm. Examples of suitable ultraviolet light sources include mercury arcs, carbon arcs, low, medium or high pressure mercury lamps, swirl-flow plasma arcs and ultraviolet light emitting diodes. Preferred ultraviolet light-emitting lamps are medium pressure mercury vapor lamps having outputs ranging from 200 to 600 watts per inch (79 to 237 watts per centimeter) across the length of the lamp tube. In certain embodiments, the coating compositions of the present invention can be cured in air.

Materials that are curable upon exposure to actinic radiation include compounds with radiation-curable functional groups, such as unsaturated groups, including vinyl groups, vinyl ether groups, epoxy groups, maleimide groups, fumarate groups and combinations of the foregoing. In certain embodiments, the radiation curable groups are curable upon exposure to ultraviolet radiation and can include, for example, acrylate groups, maleimides, fumarates, and vinyl ethers. Suitable vinyl groups include those having unsaturated ester groups and vinyl ether groups.

In certain embodiments, the radiation-curable organic film-forming binder present in the compositions of the present invention comprises a urethane (meth)acrylate. As used herein, the term “(meth)acrylate” is meant to encompass acrylates and methacrylates. As used herein, the term “urethane (meth)acrylate” refers to a polymer that has (meth)acrylate functionality and that contains a urethane linkage. As will be appreciated, such a polymer can be prepared, for example, by reacting a polyisocyanate, a polyol, and an (meth)acrylate having hydroxy groups, such as is described in U.S. Pat. No. 6,899,927 at col. 4, lines 4 to 49, the cited portion of which being incorporated herein by reference.

In certain embodiments, the radiation-curable organic film-forming binder present in the compositions of the present invention comprises a urethane (meth)acrylate comprising the reaction product of a polyol and a polyisocyanate having relatively few functional groups per molecule, often two (meth)acrylate functional groups per molecule. In some cases, such a polymer has a molecular weight of 3,000. Another example of a “urethane (meth)acrylate polymer” is described in U.S. Pat. No. 6,899,927 at col. 4, line 50 to col. 5, line 3, the cited portion of which being incorporated herein by reference.

In certain embodiments, the urethane (meth)acrylate polymer is present in the coating compositions of the present invention in an amount of at least 10 percent by weight, such as at least 20 percent by weight, with the weight percents being based on the total weight of the composition. In certain embodiments, the urethane (meth)acrylate polymer is present in the coating compositions of the present invention in an amount of no more than 60 percent by weight, such as no more than 40 percent by weight, with the weight percents being based on the total weight of the binder. The amount of urethane (meth)acrylate polymer in the compositions of the present invention can range between any combination of the recited values inclusive of the recited values.

In certain embodiments, the radiation curable coating compositions of the present invention comprise a highly functional (meth)acrylate. As used herein, the term “highly functional (meth)acrylate” refers to (meth)acrylates having three or more (meth)acrylate, often acrylate, functional groups per molecule, such as tri-, tetra-, penta-, and/or hexa-functional (meth)acrylates.

In certain embodiments, the coating compositions of the present invention comprise a tri functional (meth)acrylate. As used herein, the term “tri functional (meth)acrylate” is meant to encompass (meth)acrylate monomers and polymers comprising three reactive (meth)acrylate groups per molecule. Examples of such compounds, which are suitable for use in the present invention, are propoxylated glyceryl triacrylate, ethoxylated trimethylolpropane triacrylate, pentaerythritol triacrylate, propoxylated glyceryl triacrylate, propoxylated trimethylolpropane triacrylate, trimethylolpropane triacrylate, trimethylolpropane trimethacrylate, tris (2-hydroxy ethyl) and/or isocyanurate triacrylate.

In certain embodiments, the total amount of tri functional (meth)acrylate present in the coating compositions of the present invention is at least 40 percent by weight, such as at least 50 percent by weight, with the weight percents being based on the total weight of the binder. In certain embodiments, the total amount of tri functional (meth)acrylate present in the coating compositions of the present invention is no more than 70 percent by weight, such as no more than 60 percent by weight, with the weight percents being based on the total weight of the binder. The total amount of tri functional (meth)acrylate present in the coating compositions of the present invention can range between any combination of the recited values inclusive of the recited values

In certain embodiments, the coating compositions of the present invention comprise a tetra and/or higher functional (meth)acrylate. As used herein, the phrase “tetra and/or higher functional (meth)acrylate” is meant to encompass (meth)acrylate monomers and polymers comprising four or more reactive (meth)acrylate groups per molecule, such as tetra-, penta-, and/or hexa-functional (meth)acrylates.

As used herein, the term “tetra functional (meth)acrylate” is meant to encompass (meth)acrylates comprising four reactive (meth)acrylate groups per molecule. Examples of such materials, which are suitable for use in the present invention, include, but are not limited to, di-trimethylolpropane tetraacrylate, ethoxylated 4-pentaerythritol tetraacrylate, pentaerythritol ethoxylate tetraacrylate, pentaerythritol propoxylate tetraacrylate, including mixtures thereof.

As used herein, the term “penta functional (meth)acrylate” is meant to encompass (meth)acrylate monomers and polymers comprising five reactive (meth)acrylate groups per molecule. Suitable examples of such materials include, but are not limited to, dipentaerythritol pentaacrylate, dipentaerythritol ethoxylate pentaacrylate, and dipentaerythritol propoxylate pentaacrylate, including mixtures thereof.

As used herein, the term “hexa functional (meth)acrylate” is meant to encompass (meth)acrylate monomers and polymers comprising six reactive (meth)acrylate groups per molecule. Suitable examples of such materials include, but are not limited to, commercially available products such as EBECRYL™ 1290 and EBECRYL™ 8301 hexafunctional aliphatic urethane acrylate (both available from Cytec); EBECRYL™ 220 hexafunctional aromatic urethane acrylate (available from Cytec); EBECRYL™ 830, EBECRYL™ 835, EBECRYL™ 870 and EBECRYL™ 2870 hexafunctional polyester acrylates (all available from Cytec); EBECRYL™ 450 fatty acid modified polyester hexaacrylate (available from Cytec); DPHA™ dipentaerythritol hexaacrylate (functionality 6; available from Cytec) and mixtures of any of the foregoing.

In certain embodiments, the tetra and/or higher functional (meth)acrylate is present in the coating compositions of the present invention in an amount of at least 10 percent by weight, such as at least 15 percent by weight, with the weight percents being based on the total weight of the binder. In certain embodiments, the tetra and/or higher functional (meth)acrylate is present in the coating compositions of the present invention in an amount of no more than 30 percent by weight, such as no more than 25 percent by weight, with the weight percents being based on the total weight of the binder. The amount of tetra and/or higher functional (meth)acrylate in the compositions of the present invention can range between any combination of the recited values inclusive of the recited values.

In certain embodiments, the organic film-forming binder of the coating compositions of the present invention comprises (i) 20 to 40 percent by weight, based on the total weight of the binder, of a urethane (meth)acrylate comprising the reaction product of a polyol and a polyisocyanate comprising two (meth)acrylate groups per molecule, (ii) 40 to 60 percent by weight, based on the total weight of the binder, of a tri functional (meth)acrylate, and 10 to 30 percent by weight, based on the total weight of the binder, of a tetra and/or higher functional (meth)acrylate. In these embodiments, the amount of the various (meth)acrylates in such compositions of the present invention can range between any combination of the recited values inclusive of the recited values.

In certain embodiments, the radiation-curable compositions of the present invention are substantially free or, in some cases, completely free of mono (meth)acrylates and/or di (meth)acrylates. As used herein, the term “mono (meth)acrylate” encompasses monomers and polymers comprising one (meth)acrylate group per molecule. As used herein, the term “di (meth)acrylate” encompasses monomers and polymers comprising two (meth)acrylate group per molecule.

In certain embodiments, the coating compositions of the present invention comprise particles dispersed in the binder that have an average primary particle size of no more than 25 nanometers. In certain embodiments, the particles comprise silica particles and they have an average primary particle size of about 20 nanometers.

The average particle size can be determined by visually examining an electron micrograph of a transmission electron microscopy (“TEM”) image, measuring the diameter of the particles in the image, and calculating the average particle size based on the magnification of the TEM image. For example, a TEM image with 105,000× magnification can be produced, and a conversion factor is obtained by dividing the magnification by 1000. Upon visual inspection, the diameter of the particles is measured in millimeters, and the measurement is converted to nanometers using the conversion factor. The diameter of the particle refers to the smallest diameter sphere that will completely enclose the particle.

The shape (or morphology) of the particles can vary depending upon the specific embodiment of the present invention and its intended application. For example generally spherical morphologies (such as solid beads, microbeads, or hollow spheres), can be used, as well as particles that are cubic, platy, or acicular (elongated or fibrous). Additionally, the particles can have an internal structure that is hollow, porous or void free, or a combination of any of the foregoing, e.g., a hollow center with porous or solid walls.

Mixtures of one or more particles having different compositions, average particle sizes and/or morphologies can be incorporated into the compositions of the present invention to impart the desired properties and characteristics to the compositions.

Particles suitable for use in the coating compositions of the present invention include, for example, those described in U.S. Pat. No. 7,053,149 at col. 19, line 5 to col. 23, line 39, the cited portion of which being incorporated herein by reference.

Prior to incorporation, one class of particles which can be used according to the present invention includes sols, such as an organosol, of the particles. These sols can be of a wide variety of small-particle, colloidal silicas having an average particle size in ranges such as identified above.

In certain embodiments, the particles, prior to incorporation, comprise a silica organo sol comprising silica nanoparticles and a polymerizable (meth)acrylate binding agent. In these embodiments, the polymerizable (meth)acrylate binding agent forms at least part of the organic film-forming binder described earlier. As used herein, the term “silica organo sol” refers to a colloidal dispersion of finely divided silica particles, such as amorphous silica particles, dispersed in an organic binding agent, which, in certain embodiments of the present invention comprises a polymerizable (meth)acrylate. As used herein, the term “silica” refers to SiO₂.

Polymerizable (meth)acrylates suitable for use as a binding agent in the silica organo sols present in certain embodiments of the coating compositions of the present invention include unsaturated (meth)acrylate monomers and oligomers, such as, for example, the di functional (meth)acrylates and the highly functional (meth)acrylates described earlier.

Silica organo sols suitable for use in the present invention are commercially available. Examples include the Nanocryl® C line of products available from Hanse Chemie AG, Geesthacht, Germany. These products are low viscosity organo sols having a silica content of up to 50 percent by weight. Examples of such products, which are suitable for use in the present invention, are Nanocryl® C150, Nanocryl® C152, and Nanocryl® C153. Also suitable is Laromer PO 9026V a polyether acrylate oligomer containing nanoparticles from BASF.

In some cases, such silica particles are dispersed in an inert organic solvent, such as is the case with Nanopol® C784, which is a dispersion of silica nanoparticles in n-butyl acetate.

In certain embodiments, the particles described above are present in the coating composition in an amount greater than 10 and less than 40 percent by weight, such as from 20 to 30 percent by weight, or, in some cases, about 25 percent by weight, based on the total solids, i.e., non-volatiles, weight of the coating composition. The amount of such particles in the compositions of the present invention can range between any combination of the recited values inclusive of the recited values.

It has been surprisingly discovered that the particular combination of particle size of the particles, such as silica particles, described above, and the loading of such particles in the coating composition, is critical, as is the particular composition of the organic film-forming binder, to obtain radiation cured coatings having the required level of abrasion resistance (described below) and flexibility along with the required level of initial clarity (described below) at relatively high film thicknesses (up to 2 mil) and low color (low yellowing). Indeed, it would not have been predicted that the presence of the polyurethane acrylate described herein, in an amount of 10 to 60 percent by weight, based on the total weight of the binder in the coating compositions of the present invention, would be important to achieving the desirable high initial clarity at a film thickness up to 2 mil and low color (low yellowing) properties sought herein. It would have been expected that the amount and size of the nanoparticles used in the coating compositions described herein would determine these properties. What was discovered, however, was that even if the nanoparticles were employed in the optimal amount and size, initial clarity at film thicknesses of 2 mil was still inadequate unless the particular binder composition of the present invention was also used.

In certain embodiments, the coating compositions of the present invention further comprise an organic solvent. The amount of solvent present may range from 20 to 90 weight percent based on the total weight of the coating composition, depending on the particular composition used and the desired application technique. Suitable solvents include, but are not limited to, the following: benzene, toluene, methyl ethyl ketone, methyl isobutyl ketone, acetone, ethanol, tetrahydrofurfuryl alcohol, propyl alcohol, butyl alcohol, propylene carbonate, N-methylpyrrolidinone, N-vinylpyrrolidinone, N-acetylpyrrolidinone, N-hydroxymethylpyrrolidinone, N-butyl-pyrrolidinone, N-ethylpyrrolidinone, N-(N-octyl)-pyrrolidinone, N-(n-dodecyl)pyrrolidinone, 2-methoxyethyl ether, xylene, cyclohexane, 3-methylcyclohexanone, ethyl acetate, butyl acetate, tetrahydrofuran, methanol, amyl propionate, methyl propionate, diethylene lycol monobutyl ether, dimethyl sulfoxide, dimethyl formamide, ethylene glycol, mono- and dialkyl ethers of ethylene glycol and their derivatives, which are sold as CELLOSOLVE industrial solvents by Union Carbide, propylene glycol methyl ether and propylene glycol methyl ether acetate, which are sold as DOWANOL® PM and PMA solvents, respectively, by Dow Chemical and mixtures of such recited solvents.

Depending on the desired application technique, the coating compositions of the present invention, may be embodied as a liquid coating composition that is substantially solvent-free and water-free, i.e., substantially 100% solids coatings. As used herein, the term “substantially 100% solids” means that the composition contains substantially no volatile organic solvent (“VOC”), and has essentially zero emissions of VOC, and contains substantially no water. In certain embodiments, the substantially 100% solids coatings of the present invention comprise less than 5 percent VOC and water by weight of the coating composition, in some cases less than 2 percent by weight of the coating composition, in yet other cases, less than 1 percent by weight of the coating composition, and, in yet other cases, VOC and water are not present in the coating composition at all.

In certain embodiments, the coating compositions of the present invention may also comprise additional optional ingredients, such as those ingredients well known in the art of formulating surface coatings. Such optional ingredients may comprise, for example, surface active agents, flow control agents, thixotropic agents, anti-gassing agents, antioxidants, light stabilizers, UV absorbers and other customary auxiliaries. Any such additives known in the art can be used.

In certain embodiments, particularly when the coating compositions of the present invention are to be cured by UV radiation, such compositions also comprise a photoinitiator. As will be appreciated by those skilled in the art, a photoinitiator absorbs radiation during cure and transforms it into chemical energy available for the polymerization. Photoinitiators are classified in two major groups based upon a mode of action, either or both of which may be used in the compositions of the present invention. Cleavage-type photoinitiators include acetophenones, α-aminoalkylphenones, benzoin ethers, benzoyl oximes, acylphosphine oxides and bisacylphosphine oxides and mixtures thereof. Abstraction-type photoinitiators include benzophenone, Michler's ketone, thioxanthone, anthraquinone, camphorquinone, fluorone, ketocoumarin and mixtures thereof.

Specific nonlimiting examples of photoinitiators that may be used certain embodiments of the coating compositions of the present invention include benzil, benzoin, benzoin methyl ether, benzoin isobutyl ether benzophenol, acetophenone, benzophenone, 4,4′-dichlorobenzophenone, 4,4′-bis(N,N′-dimethylamino)benzophenone, diethoxyacetophenone, fluorones, e.g., the H-Nu series of initiators available from Spectra Group Ltd., 2-hydroxy-2-methyl-1-phenylpropan-1-one, 1-hydroxycyclohexyl phenyl ketone, 2-isopropylthixantone, α-aminoalkylphenone, e.g., 2-benzyl-2-dimethylamino-1-(4-morpholinophenyl)-1-butanone, acylphosphine oxides, e.g., 2,6-dimethylbenzoyldlphenyl phosphine oxide, 2,4,6-trimethylbenzoyldiphenylphosphine oxide, bis (2,4,6-trimethylbenzoyl) phenyl phosphine oxide, 2,6-dichlorobenzoyl-diphenylphosphine oxide, and 2,6-dimethoxybenzoyldiphenylphosphine oxide, bisacylphosphine oxides, e.g., bis(2,6-dimethyoxybenzoyl)-2,4,4-trimethylepentylphosphine oxide, bis(2,6-dimethylbenzoyl)-2,4,4-trimethylpentylphosphine oxide, bis (2,4,6-trimethylbenzoyl)-2,4,4-trimethylpentylphosphine oxide, and bis(2,6-dichlorobenzoyl)-2,4,4-trimethylpentylphosphine oxide, and mixtures thereof.

In certain embodiments, the coating compositions of the present invention comprise 0.01 up to 15 percent by weight of photoinitiator or, in some embodiments, 0.01 up to 10 percent by weight, or, in yet other embodiments, 0.01 up to 5 percent by weight of photoinitiator based on the total weight of the coating composition. The amount of photoinitiator present in the coating compositions can range between any combination of these values inclusive of the recited values.

In certain embodiments, the coating compositions of the present invention further comprise a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used in the compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 0.1 to 65 weight percent of the present compositions, such as from 0.1 to 10 weight percent or 0.5 to 5 weight percent, with weight percent based on the total weight of the compositions of the present invention

The coating compositions of the present invention can be prepared by any suitable technique, including those described in the Examples herein. The coating components can be mixed using, for example, stirred tanks, dissolvers, including inline dissolvers, bead mills, stirrer mills, static mixers, among others. Where appropriate, it is carried out with exclusion of actinic radiation in order to prevent damage to the coating of the invention which is curable with actinic radiation. In the course of preparation, the individual constituents of the mixture according to the invention can be incorporated separately. Alternatively, the mixture of the invention can be prepared separately and mixed with the other constituents.

The coating compositions of the present invention can be applied to any suitable substrate, however, in many cases, the substrate is a plastic substrate, such as thermoplastic substrate, including, but not limited to, polycarbonate, acrylonitrile butadiene styrene, blends of polyphenylene ether and polystyrene, polyetherimide, polyester, polysulfone, acrylic, and copolymers and/or blends thereof.

Prior to applying the coating composition to such a substrate, the substrate surface may be treated by cleaning. Effective treatment techniques for plastics include ultrasonic cleaning; washing with an aqueous mixture of organic solvent, e.g., a 50:50 mixture of isopropanol:water or ethanol:water; UV treatment; activated gas treatment, e.g., treatment with low temperature plasma or corona discharge, and chemical treatment such as hydroxylation, i.e., etching of the surface with an aqueous solution of alkali, e.g., sodium hydroxide or potassium hydroxide, that may also contain a fluorosurfactant. See U.S. Pat. No. 3,971,872, column 3, lines 13 to 25; U.S. Pat. No. 4,904,525, column 6, lines 10 to 48; and U.S. Pat. No. 5,104,692, column 13, lines 10 to 59, which describe surface treatments of polymeric organic materials.

The coating compositions of the present invention may be applied to the substrate using, for example, any conventional coating technique including flow coating, dip coating, spin coating, roll coating, curtain coating and spray coating. Application of the coating composition to the substrate may, if desired, be done in an environment that is substantially free of dust or contaminants, e.g., a clean room. Coatings prepared by the process of the present invention may range in thickness from 0.1 to 50 microns (μm). However, it has been discovered that coating thicknesses of from 3 to 20 μm can be critical to achieving the transparency and abrasion resistance properties described below.

Following application of a coating composition of the present invention to the substrate, the coating is cured, such as by exposing, in air, the coated substrate to the actinic radiation conditions described earlier. As used herein, the terms “cured” and “curing” refer to the at least partial crosslinking of the components of the coating that are intended to be cured, i.e., cross-linked. In certain embodiments, the crosslink density, i.e., the degree of crosslinking, ranges from 35 to 100 percent of complete crosslinking. The presence and degree of crosslinking, i.e., the crosslink density, can be determined by a variety of methods, such as dynamic mechanical thermal analysis (DMTA) using a Polymer Laboratories MK III DMTA analyzer, as is described in U.S. Pat. No. 6,803,408, at col. 7, line 66 to col. 8, line 18, the cited portion of which being incorporated herein by reference.

In certain embodiments, the coatings formed from the coating compositions of the present invention are abrasion resistant and exhibit excellent initial clarity at film thicknesses up to 2 mil. For purposes of the present invention, the term “initial clarity” means that the cured coating has an initial % haze, prior to any Taber abrasion, of less than 1%. For purposes of the present invention, the term “abrasion resistant” means that the cured coating has a % haze of less than 15%, in some cases less than 10%, when measured after 100 taber abrasion cycles in accordance with a standard Taber Abrasion Test (ASTM D 1044-49 modified by using the conditions described in the Examples). In certain embodiments, the cured coatings of the present invention also have a % haze of less than 25%, in some cases less than 15%, when measured after 300 taber abrasion cycles in accordance with a standard Taber Abrasion Test (ASTM D 1044-49 modified by using the conditions described in the Examples NSI/SAE 26.1-1996). In addition, the coating compositions of the present invention exhibit low color, which means that the coating have a yellow index of less than 1.3 when measured according to ASTM D1925 using a Hunter Lab spectrophotometer.

Illustrating the invention are the following examples, which, however, are not to be considered as limiting the invention to their details. Unless otherwise indicated, all parts and percentages in the following examples, as well as throughout the specification, are by weight.

### EXAMPLES

### Example 1

Coating compositions were prepared from the ingredients listed in Table 1. Charge I was added to a suitable flask and stirred. Charge II was then added to the flask and the mixture of Charge I and Charge II was stirred under the solids had dissolved. Charge III was then added under continued agitation. The premixed combination of Charges I, II and III was then added to a flask containing Charge IV under agitation. The resulting combination was filtered twice with a 0.45 μm filter.

TABLE 1

| Charge | Component | Formula Weight (g) |
|---|---|---|
| I | Polyurethane diacrylate¹ | 110.15 |
| | Sartomer SR399² | 83.51 |
| | Sartomer SR454³ | 70.13 |
| II | Daracure 1173⁴ | 12.03 |
| | Irgacure 184⁵ | 1.46 |
| | Genocure MBF⁶ | 1.51 |
| | Benzophenone | 8.84 |
| III | PM Acetate | 45.23 |
| | n-butyl acetate | 158.30 |
| | Isobutanol | 113.07 |
| | BYK-UV 3500⁷ | 0.48 |
| | Modaflow 2100⁸ | 1.04 |
| | TEGOrad 2100⁹ | 5.19 |
| IV | Nanocryl C150¹⁰ | 259.74 |

¹A 73% solids solution in organic solvent of a polyurethane acrylate resin having a molecular weight of about 3,000 comprising the reaction product of a polyol and a polyisocyanate comprising two acrylate groups per molecule.
²Dipentaerythritol pentaacrylate commercially available from Sartomer Company, Inc., Exton, PA.
³Ethoxylated trimethylolpropane triacrylate commercially available from Sartomer Company, Inc., Exton, PA.
⁴Photoinitiator commercially available from CIBA Specialty Chemicals.
⁵Photoinitiator commercially available from CIBA Specialty Chemicals.
⁶Photoinitiator commercially available from Rahn, Inc.
⁷Polyether modified acryl functional polydimethylsiloxane commercially available from Byk-Chemie.
⁸Flow modifier commercially available from Cytec Surface Specialties.
⁹Flow modifier commercially available from Tego Chemie, Essen, Germany.
¹⁰Silica organo sol commercially available from Hanse Chemie AG, Geesthacht that is a 50/50 weight percent dispersion of amorphous silica particles having an average primary particle size of about 20 nanometers in trimethylolpropane triacrylate.

To coat samples with foregoing composition, Mokrolon® transparent polycarbonate plaques (Bayer AG) were wiped with 2-propanol. The coating solution was spin applied on un-primed substrate and cured with H bulb with UVA dosage of 1 J/cm² and intensity of 0.6 W/cm² under air. Samples with varied final dry film thickness ranging from 3-18 μm were prepared. Coated samples were evaluated for adhesion, optical clarity and taber abrasion resistance.

As demonstrated in Table 2, polycarbonate samples coated with coatings of the present invention were highly transparent with low initial haze over varied film thickness. The coatings also provided good adhesion and abrasion resistance.

TABLE 2

| Testing | Results | | | | |
|---|---|---|---|---|---|
| Film Thickness (μm) | 3 | 5 | 8 | 12 | 18 |
| Adhesion¹ | 5 | 5 | 5 | 5 | 5 |
| Initial Haze %² | 0.1 | 0.1 | 0.1 | 0.1 | 0.2 |
| Haze % after 100 cycles | 9.35 | 10.08 | 10.22 | 7.88 | 9.96 |
| of Taber Abrasion³ | | | | | |
| Haze % after 300 cycles | 10.81 | 12.98 | 13.04 | 11.27 | 11.02 |
| of Taber Abrasion³ | | | | | |

¹Adhesion: Crosshatch, Nichibon LP-24 adhesive tape. Rating scale 0-5 (no adhesion-100% adhesion after tape pull).
²Haze % was measured with Hunter Lab spectrophotometer.
³Taber Abrasion: Taber 5150 Abrader, CS-10 wheels, S-11 refacing disk, 500 grams of weight. Haze % was measured after 300 taber cycles. Haze % < 25% after 300 taber cycles is acceptable.

### Comparative Examples 2, 3, 4

Radiation curable coating compositions of examples 2, 3, 4 were prepared from the ingredients listed in Table 3. Charge III was added to the flask followed by Charge I and Charge II under agitation. The mixture was stirred for appropriate time to form a clear solution.

TABLE 3

| | | Formula Weight (g) | | |
|---|---|---|---|---|
| Charge | Component | Example 2 | Example 3 | Example 4 |
| I | Ebecryl 8301¹ | 100.00 | — | 10.40 |
| | Ebecryl 810² | — | 3.05 | — |
| | 1,6-Hexanediol diacrylate³ | — | — | 35.84 |
| II | Daracure 1173⁴ | — | 0.48 | 2.85 |
| | Irgacure 184⁵ | 9.15 | 0.56 | 1.90 |
| III | Highlink OG 502-31 | 23.00 | — | — |
| | (13 nm)⁶ | | | |
| | Highlink OG 108-32 | 60.00 | — | — |
| | (25 nm)⁷ | | | |
| | Highlink OG 103-31 | — | 26.30 | — |
| | (13 nm)⁸ | | | |
| | Nanocryl C140 (20 nm)⁹ | — | — | 53.76 |

¹A hexa-functional aliphatic urethane acrylate commercially available from Cytec Industries.
²Multifunctional polyester acrylate commercially available from Cytec Industries.
³Difunctional monomer commercially available from Cray Valley.
⁴Photoinitiator commercially available from CIBA Specialty Chemicals.
⁵Photoinitiator commercially available from CIBA Specialty Chemicals.
⁶30% colloidal silica in isopropanol commercially available from Clariant.
⁷30% colloidal silica in 1,6-Hexanediol diacrylate commercially available from Clariant.
⁸30% colloidal silica in diacrylate commercially available from Clariant.
⁹Silica organo sol commercially available from Nanoresins AG, Geesthacht that is a 50/50 weight percent dispersion of amorphous silica particles having an average primary particle size of about 20 nanometers in1,6-Hexanediol diacrylate.

To coat samples with foregoing composition, Makrolon® transparent polycarbonate plaques (Bayer AG) were wiped with 2-propanol. The coating solution was spin applied on un-primed substrate and cured with H bulb with UVA dosage of 1 J/cm² and intensity of 0.6 W/cm² under air. Samples with final dry film thickness around 15.0 μm were prepared. Coated samples were evaluated for optical clarity and yellowness.

As demonstrated in Table 4, polycarbonate samples coated with different acrylate coating systems based on nanosilica dispersions exhibited different levels of initial haze and yellowness.

TABLE 4

| | Results | | |
|---|---|---|---|
| Testing | Example 2 | Example 3 | Example 4 |
| Initial Haze %¹ | 1.2 | 4.0 | 14.40 |
| Color (YI) %² | 2.01 | 4.25 | 11.54 |

¹Haze % was measured with Hunter Lab spectrophotometer.
²Color based on yellow index was measured with Hunter Lab spectrophotometer.

### Examples 5, 6, 7

Radiation curable coating compositions of Examples 5, 6 and 7 were prepared from the ingredients listed in Table 5. Charge IV was added to the flask followed by Charge I and Charge II under agitation. Then add Charge III and in order under agitation. The mixture was stirred for appropriate time to form a clear solution.

TABLE 5

| | | Formula Weight (g) | | |
|---|---|---|---|---|
| Charge | Component | Example 5 | Example 6 | Example 7 |
| I | Polyurethane acrylate¹ | 41.22 | — | 12.65 |
| | Sartomer SR399² | — | 16.47 | 9.59 |
| | Sartomer SR454³ | — | 13.82 | 8.05 |
| II | Daracure 1173⁴ | 1.38 | 1.38 | 1.38 |
| | Irgacure 184⁵ | 0.17 | 0.17 | 0.17 |
| | Genocure MBF⁶ | 0.17 | 0.17 | 0.17 |
| | Benzophenone | 1.02 | 1.02 | 1.02 |
| III | PM Acetate | 5.19 | — | — |
| | n-butyl acetate | 18.18 | 18.18 | 18.18 |
| | Isobutanol | 12.99 | — | — |
| | BYK-UV 3500⁷ | 0.06 | 0.06 | 0.06 |
| | Modaflow 2100⁸ | 0.12 | 0.12 | 0.12 |
| | TEGOrad 2100⁹ | 0.60 | 0.60 | 0.60 |
| IV | Nanocryl C150¹⁰ | 18.90 | 29.83 | 29.83 |

| | | | |
|---|---|---|---|
| % wt of urethane acrylate in total | 76.2% | 0 | 22.2% |
| organic binder | | | |

¹A 73% solids solution in organic solvent of a polyurethane acrylate resin having a molecular weight of about 3,000 and comprising the reaction product of a polyol and a polyisocyanate comprising two acrylate groups.
²Dipentaerythritol pentaacrylate commercially available from Sartomer Company, Inc., Exton, PA.
³Ethoxylated trimethylolpropane triacrylate commercially available from Sartomer Company, Inc., Exton, PA.
⁴Photoinitiator commercially available from CIBA Specialty Chemicals.
⁵Photoinitiator commercially available from CIBA Specialty Chemicals.
⁶Photoinitiator commercially available from Rahn, Inc.
⁷Polyether modified acryl functional polydimethylsiloxane commercially available from Byk-Chemie.
⁸Flow modifier commercially available from Cytec Surface Specialties.
⁹Flow modifier surfactant commercially available from Tego Chemie, Essen, Germany.
¹⁰Silica organo sol commercially available from Nanoresins AG, Geesthacht that is a 50/50 weight percent dispersion of amorphous silica particles having an average primary particle size of about 20 nanometers in trimethylolpropane triacrylate.

To coat samples with foregoing composition, Makrolon® transparent polycarbonate plaques (Bayer AG) were wiped with 2-propanol. The coating solution was spin applied on un-primed substrate and cured with H bulb with UVA dosage of 1 J/cm² and intensity of 0.6 W/cm² under air. Coated samples were evaluated for abrasion resistance, optical clarity, and yellowness.

As demonstrated in Table 6, polycarbonate samples coated with coatings with over 60% of polyurethane acrylate in binder (i.e. example 5) showed low abrasion resistance, high yellowness, and reduced clarity at a film thickness of about 2 mil. Samples coated with coatings containing no polyurethane acrylate (i.e. example 6) exhibited low flexibility.

TABLE 6

| | Results | | |
|---|---|---|---|
| Testing | Example 5 | Example 6 | Example 7 |
| Film Thickness (μm) | 12.5 | 50 | 43.5 |
| Initial Haze %¹ | 0.37 | 2.1 | 0.96 |
| Haze % after 100 cycles of Taber | 26.41 | NA (Panel | 10.44 |
| Abrasion² | | cracking) | |
| Haze % after 300 cycles of Taber | 37.38 | NA (Panel | 16.04 |
| Abrasion² | | cracking | |
| Color (YI) %³ | 1.72 | 3.48 | 2.7 |
| Impact resistance (0.625″ ball | No | Cracking (at | No |
| indenter, 2 lb f dropping weight | damage | 2.5″ height) | damage |
| drops at 7″ height) | | | |

¹Haze % was measured with Hunter Lab spectrophotometer.
²Taber Abrasion: Taber 5150 Abrader, CS-10 wheels, S-11 refacing disk, 500 grams of weight. Haze % was measured after100 and 300 Taber cycles. Haze % <25% after 300 Taber cycles is acceptable
³Color based on yellow index was measured with Hunter Lab spectrophotometer.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A radiation curable coating composition comprising:
(a) an organic film-forming binder comprising:
(i) 10 to 60 percent by weight, based on the total weight of the binder, of a urethane (meth)acrylate comprising the reaction product of a polyol and a polyisocyanate comprising two (meth)acrylate groups per molecule; and
(ii) 40 to 90 percent by weight, based on the total weight of the binder, of a highly functional (meth)acrylate; and
(b) >10 and <40 percent by weight, based on the total solids weight of the composition, of particles having an average primary particle size of no more than 25 nanometers.

2. The composition of claim 1, wherein the cured coating is substantially free of an inorganic film-forming binder.

3. The composition of claim 1, wherein the organic film-forming binder comprises:
(i) 20 to 40 percent by weight, based on the total weight of the binder, of the urethane (meth)acrylate,
(ii) 40 to 60 percent by weight, based on the total weight of the binder, of a tri functional (meth)acrylate, and
(iii) 10 to 30 percent by weight, based on the total weight of the binder, of a tetra and/or higher functional (meth)acrylate.

4. The composition of claim 1, wherein the particles comprise silica particles.

5. The composition of claim 4, wherein the silica particles comprise amorphous silica particles.

6. The composition of claim 4, wherein the silica particles have an average primary particle size of about 20 nanometers.

7. A radiation cured coating comprising:
(a) an organic film-forming binder comprising the reaction product of a polyol and a polyisocyanate comprising two (meth)acrylate groups per molecule; and
(b) particles dispersed in the binder that have an average primary particle size of no more than 25 nanometers, wherein
the cured coating has:
(1) a thickness of 3 to 20 microns,
(2) an initial haze of <1%; and
(3) a haze after 100 Taber cycles of <15%.

8. The cured coating of claim 7, wherein the particles comprise silica particles.

9. The cured coating of claim 7, wherein the particles are present in the coating composition in an amount >10 and <40 percent by weight based on the total weight of the cured coating.

10. The cured coating of claim 7, wherein the cured coating is deposited on a plastic substrate.

11. The cured coating of claim 7, wherein the cured coating has a % haze of less than 10% when measured after 100 taber abrasion cycles in accordance with ANSI/SAE 26.1-1996 and a % haze of less than 15% when measured after 300 taber abrasion cycles in accordance with ANSI/SAE 26.1-1996.

12. The cured coating of claim 7, wherein the cured coating is substantially free of an inorganic film-forming binder.

13. A method of coating a substrate, comprising:
(a) depositing onto at least a portion of the substrate a coating composition comprising:
(1) a radiation curable organic film-forming binder comprising a urethane (meth)acrylate comprising the reaction product of a polyol and a polyisocyanate comprising two (meth)acrylate groups per molecule; and
(2) particles having an average primary particle size of no more than 25 nanometers; and
(b) curing the composition by exposing the composition to actinic radiation in air to produce a cured coating comprising:
(1) a thickness of 3 to 20 microns,
(2) an initial haze of <1%, and
(3) a haze after 100 Taber cycles of <15%.

14. The method of claim 13, wherein the particles comprise silica particles.

15. The method of claim 13, wherein the particles are present in the coating composition in an amount >10 and <40 percent by weight based on the total weight of the cured coating.

16. The method of claim 13, wherein the substrate is a plastic substrate.

17. The method of claim 13, wherein the cured coating is substantially free of an inorganic film-forming binder.
